(19) United States
(12) Patent Application Publication
(10) Pub. No.: US 2007/0260937 A1
(43) Pub. Date: Nov. 8, 2007

(54) Systems and methods for selectively logging test data

(76) Inventors: Carli Connally, Fort Collins, CO (US); Kristin N. Casterton, Fort Collins, CO (US)

Correspondence Address: VERIGY, 4700 INNOVATION WAY, BLDG D1, FORT COLLINS, CO, 80528, US

(21) Appl. No.: 11/404,145

(22) Filed: Apr. 13, 2006

(51) Int. Cl. G06F 11/00

(52) U.S. Cl. 714/45

(57) ABSTRACT

There are disclosed systems and methods for selectively logging test data. In an embodiment, a system includes code to monitor test data generated by a plurality of devices and to generate statistics related to the test data; and code to in response to the statistics related to the test data, selectively adjust a tester that generates the test data, to modify the test data logged by the tester for the plurality of devices. In one embodiment, a method includes monitoring the test data generated by a plurality of devices and generating statistics related to the test data; and in response to the statistics related to the test data, selectively adjusting a tester that generates the test data, to modify the test data obtained from the devices. Other embodiments are also disclosed.

### BACKGROUND

A very large amount of information can be logged for testing system-on-a-chip (SOC) devices. Many parametric measurements may be obtained for a single test. Potentially, all of these measurements may be logged together with corresponding limits of the tests. This may take a significant amount of time, system memory and file space.

When the production and testing processes are stable, a user may only need to obtain summary level information. Generally, when a problem occurs in production or with the tester, more detailed information may be needed to determine the problem.

Typically, a user only logs a sampling of the detailed information obtained by a tester. For example, the user may log detailed information, which may include measurements and limits, for every fifth device tested. Rudimentary information, such as pass/fail information, may be logged for the other tested devices. On the Agilent 93000 tester, the user may select how frequently to capture detailed test data.

One disadvantage is that, for a particular device, all detailed results must typically be logged or none of the detailed results are logged. Unnecessary detailed data must usually be logged in order to obtain needed data.

Currently, a user cannot predict if a problem will occur and change the data capture rate. A user must manually notice when there is a problem to change the setting for the data capture. Many devices may have to be retested in order to obtain needed detailed data. The user may not easily detect when the test results are drifting and more detailed information is needed.

### SUMMARY OF THE INVENTION

In an embodiment, there is provided a system for selectively logging test data, the system comprising code to monitor test data generated by a plurality of devices and to generate statistics related to the test data; and code to, in response to the statistics related to the test data, selectively adjust a tester that generates the test data, to modify the test data logged by the tester for the plurality of devices.

In another embodiment, there is provided a method for selectively logging test data, the method comprising monitoring the test data generated by a plurality of devices and generating statistics related to the test data; and in response to the statistics related to the test data, selectively adjusting a tester that generates the test data, to modify the test data obtained from the devices.

Other embodiments are also disclosed.

### BRIEF DESCRIPTION OF THE DRAWINGS

Illustrative embodiments of the invention are illustrated in the drawings, in which:

FIG. 1 illustrates a system for selectively logging test data;

FIG. 2 illustrates a feedback signal generated by the code for selectively adjusting tester of the system shown in FIG. 1;

FIG. 3 illustrates a tester optionally incorporated in the system shown in FIG. 1, the tester contains code for monitoring test data and code for selectively adjusting the tester;

FIG. 4 illustrates a controller optionally incorporated in the system shown in FIG. 1, the controller having code for monitoring test data obtained by the tester and code for selectively adjusting the tester; and

FIG. 5 illustrates a method for selectively logging test data.

### DETAILED DESCRIPTION OF AN EMBODIMENT

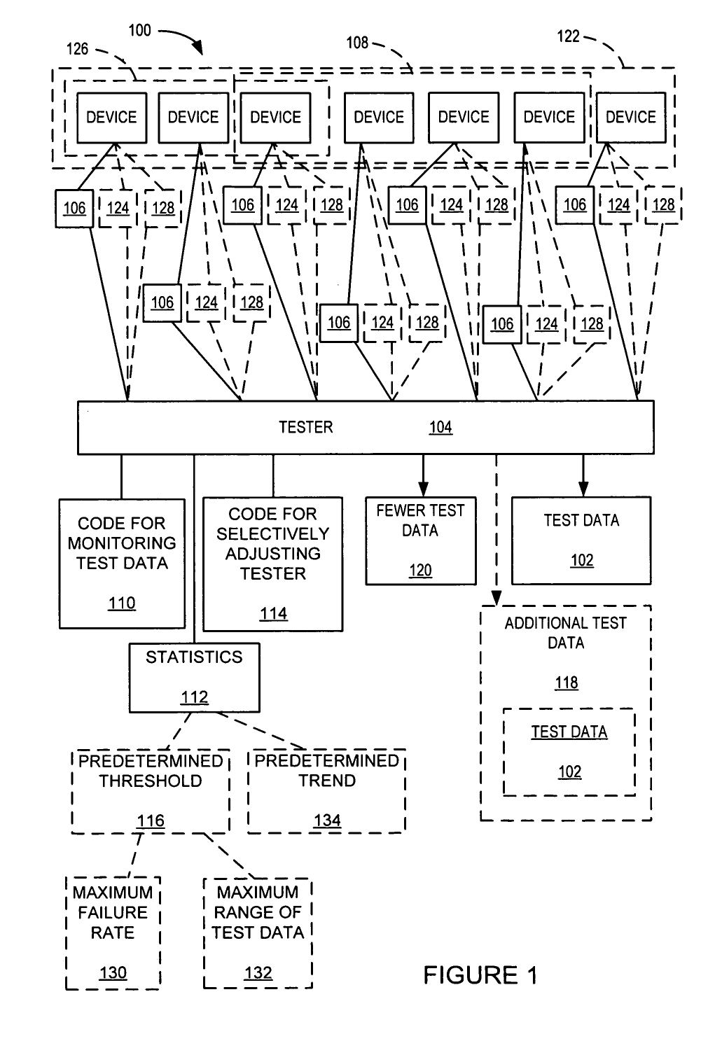

Looking at FIG. 1, and in an embodiment, there is shown a system 100 for selectively logging test data 102. System 100 may include a tester 104 for performing tests 106 on devices 108, and for logging test data 102 obtained from devices 108. System 100 may include code 110 for monitoring test data 102 obtained by tester 104 to generate statistics 112 related to test data 102. System 100 may include code 114 for selectively adjusting tester 104 to modify test data 102 logged from devices 108 in response to statistics 112 related to test data 102.

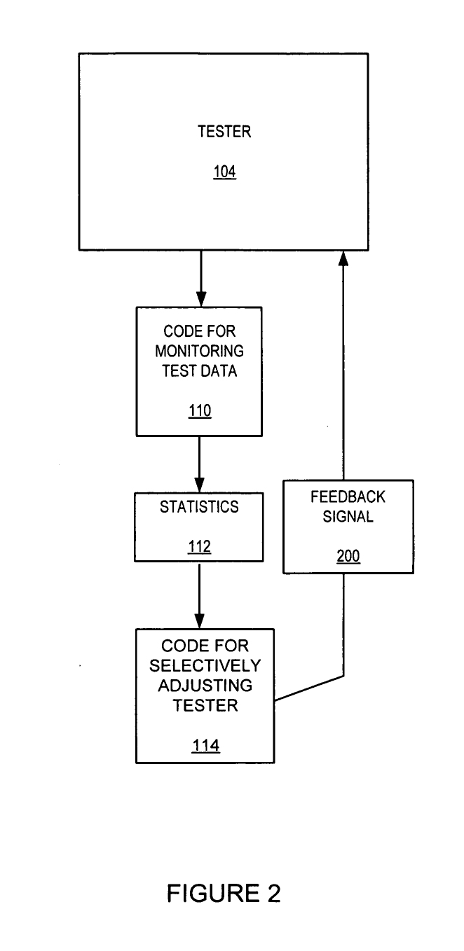

Referring to FIG. 2, and in one embodiment, system 100 may include a feedback signal 200 generated by code 114 for selectively adjusting tester 104 corresponding to statistics 112 related to test data 102. Feedback signal 200 may be used to adjust test data 102 logged by tester 104 from devices 108.

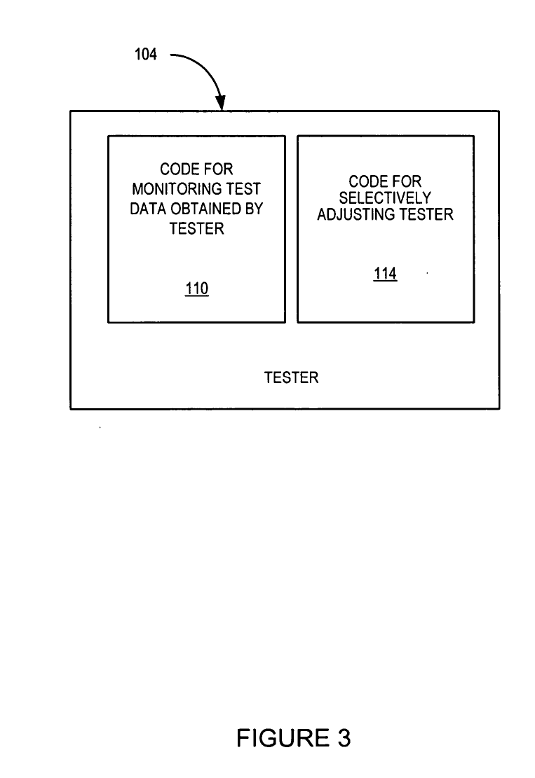

Referring now to FIG. 3, and in an embodiment, tester 104 may contain code 110 for monitoring test data 102. Tester 104 may also contain code 110 for selectively adjusting tester 104.

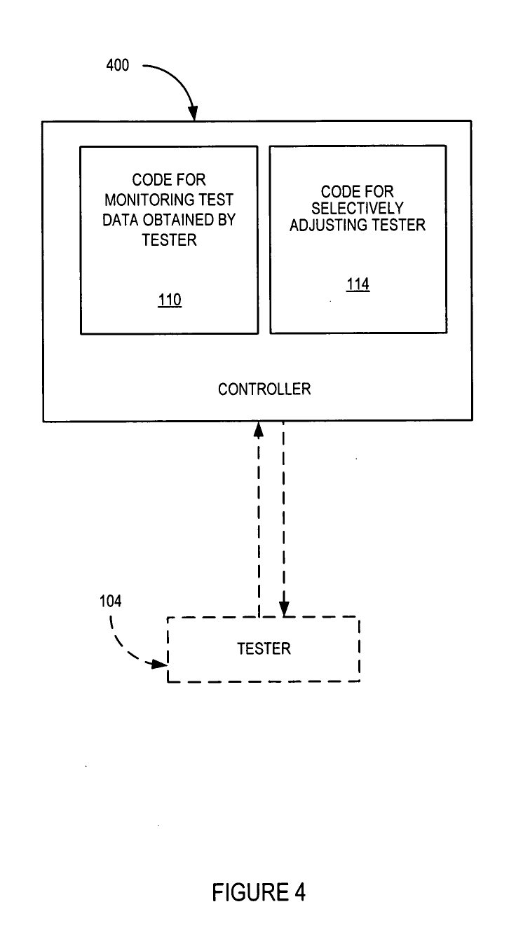

Looking at FIG. 4, and in another embodiment, system 100 may further include a controller 400 having code 110 for monitoring test data 102 obtained by tester 104. Controller 400 may include code 114 for selectively adjusting tester 104. Controller 400 may be separate from tester 104.

In an embodiment, tester 104 may include automatic test equipment (ATE), which is referred to hereinbelow as either automatic test equipment 104. Automatic test equipment 104 may contains code 104 for monitoring test data 102. Automatic test equipment 104 may contain code 114 for selectively adjusting tester 104.

Referring now to FIG. 1, and in one embodiment, statistics 112 related to test data 102 may be compared to a predetermined threshold 116. Code 114 for selectively adjusting tester 104 may adjust tester 104 to obtain additional test data 118 when statistics 112 are outside of the predetermined threshold. If statistics 112 return within predetermined threshold 116, code 114 for selectively adjusting tester 104 may readjusts the tester to obtain fewer test data 120. Fewer test data 120 may be the same as, or similar to, test data 102 initially logged by tester 104. Alternatively, fewer test data 120 may be less than or otherwise different than test data 102 initially logged by tester 104.

Additional test data 118 may include test results obtained from additional devices 122. Additional test data 118 may include test results obtained from additional tests 124 performed on each of devices 108. Additional test data 118 may include test results in which individual pin results are logged.

Fewer test data 120 may include test results obtained from fewer devices 126. Fewer test data 120 may include test results obtained from fewer tests 128 performed on each of devices 108. Fewer test data 120 may include test results in which individual pin results are not logged.

Predetermined threshold 116 may include a maximum failure rate 130 for devices 108. Predetermined threshold 116 may include a maximum range of test data 132 from devices 108. In one embodiment, predetermined threshold 116 may be selectively configurable by a user.

In an embodiment, statistics 112 related to test data 102 may be compared to a predetermined trend 134. When statistics 112 indicate more failures than predetermined trend 134, code 114 for selectively adjusting tester 104 may adjust tester 104 to obtain additional test data 118. When statistics 112 indicate less failures than predetermined trend 134, code 114 for selectively adjusting tester 104 may readjust tester 104 to obtain fewer test data 112.

In another embodiment, when statistics 112 are outside of a given range of predetermined trend 134, code 114 for selectively adjusting tester 104 may readjust tester 104 to obtain additional test data 118. When statistics 112 return within the given range of predetermined trend 134, code 114 for selectively adjusting tester 104 may readjust tester 104 to obtain fewer test data 120.

In an embodiment, system 100 may track statistics 112 for high-level data such as yield, and system 100 may also track statistics 112 for individual measurements such as standard deviation, Cp, Cpk, etc. Thresholds 116 may be preset, such as device thresholds for each kind of statistic 112. When one statistic 112, such as device yield, goes outside of thresholds 116, system 100 may automatically change settings on tester 104 to increase the amount of test data 102 being logged as appropriate. If a calculated statistic 112 goes from outside threshold 116 to within threshold 116, system 100 may automatically change the settings on tester 104 to decrease the amount of test data 102 being logged.

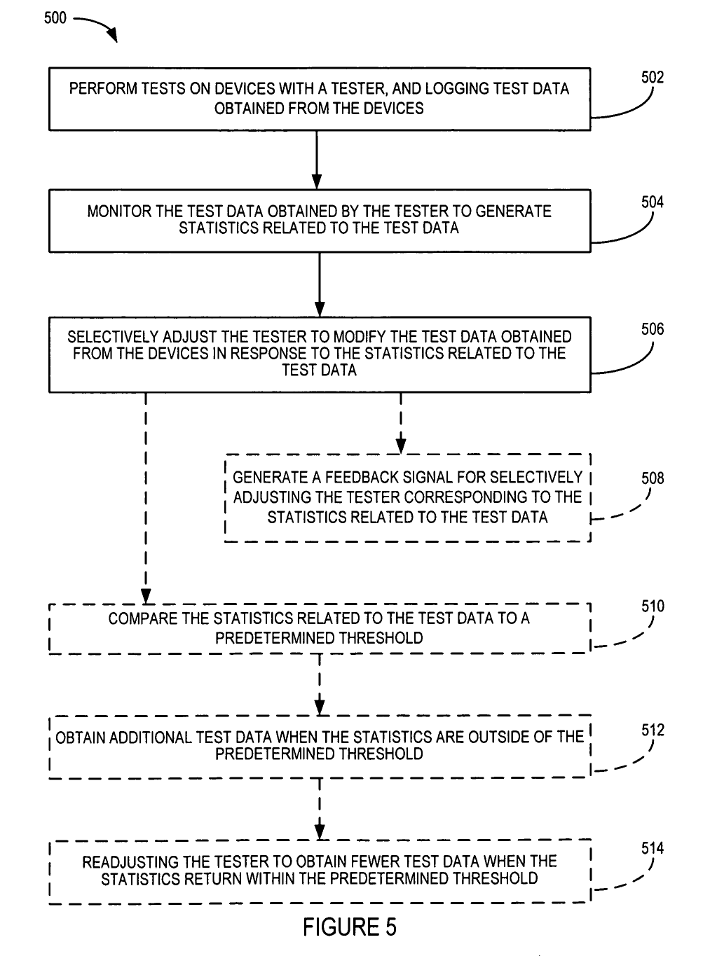

Looking now at FIG. 5, and in an embodiment, there is shown a method 500 for selectively logging test data. Method 500 may include performing 502 tests on devices with a tester, and logging test data obtained from the devices. Method 500 may include monitoring 504 the test data obtained by the tester to generate statistics related to the test data. Method 500 may include selectively adjusting 506 the tester to modify the test data obtained from the devices in response to the statistics related to the test data.

In another embodiment, method 500 may optionally include generating 508 a feedback signal for selectively adjusting the tester corresponding to the statistics related to the test data. The feedback signal may selectively adjust the test data obtained by the tester from the devices.

In one embodiment, the step of monitoring 504 the test data to generate statistics related to the test data may be performed by the tester. In another embodiment, the step of monitoring 504 the test data to generate statistics related to the test data may be performed by a controller.

In an embodiment, the step of performing 502 tests on devices with the tester may be performed by automatic test equipment.

In one embodiment, method 500 may optionally include comparing 510 the statistics related to the test data to a predetermined threshold, and obtaining 512 additional test data when the statistics are outside of the predetermined threshold. Method 500 may still further include readjusting 514 the tester to obtain fewer test data when the statistics return within the predetermined threshold.

The step of obtaining 512 additional test data may include obtaining test results from additional devices. In another embodiment, the step of obtaining 512 additional test data may include obtaining test results from additional tests performed on each of the devices.

The step of readjusting 514 the tester to obtain fewer test data may include obtaining test results from fewer devices. In another embodiment, the step of readjusting 514 the tester to obtain fewer test data may include obtaining test results by performing fewer tests on each of the devices.

In an embodiment, test data may be monitored during the logging process so to determine which test data should be logged. Logging high-level information may involve tracking data trends. If a failing trend is identified for the entire testflow or for an individual testsuite or test, the amount of data logged for the entire testflow or for an individual testsuite or test may be increased.

In another embodiment, detailed results for an individual test or for entire testflows may be logged. If the results are passing and close in range, then amount of detailed data being logged for the entire testflow or for an individual test suite or for a test may be decreased.

In an embodiment, the results of tests do not have to closely monitored by users to make determinations when to increase or decrease data flow. Similarly, a tester's data logging settings do not have to be manually changed by the users.

Furthermore, the amount of data being logged may be customized to cover only problematic tests. This may reduce the amount of data that being logged while logging needed test data.

What is claimed is:

1. A system for selectively logging test data, the system comprising:
code to monitor test data generated by a plurality of devices and to generate statistics related to the test data; and
code to, in response to the statistics related to the test data, selectively adjust a tester that generates the test data, to modify the test data logged by the tester for the plurality of devices.

2. A system in accordance with claim 1, further comprising a feedback signal generated by the code for selectively adjusting the tester corresponding to the statistics related to the test data, and wherein the feedback signal adjusts the test data logged by the tester from the devices.

3. A system in accordance with claim 1, further comprising a tester for performing tests on the devices, and for logging test data obtained from the devices, wherein the tester contains the code for monitoring the test data, and wherein the tester contains the code for selectively adjusting the tester.

4. A system in accordance with claim 1, further comprising a controller having the code for monitoring the test data obtained by the tester, and the code for selectively adjusting the tester, and wherein the controller is separate from the tester.

5. A system in accordance with claim 1, wherein the tester contains the code for monitoring the test data, and wherein the tester contains the code for selectively adjusting the tester.

6. A system in accordance with claim 1, wherein the statistics related to the test data are compared to a predetermined threshold, wherein the code for selectively adjusting the tester adjusts the tester to obtain additional test data when the statistics are outside of the predetermined threshold.

7. A system in accordance with claim 6, wherein the code for selectively adjusting the tester readjusts the tester to obtain fewer test data when the statistics return within the predetermined threshold.

8. A system in accordance with claim 7, wherein the fewer test data includes test results obtained from fewer tests performed on each of the devices.

9. A system in accordance with claim 6, wherein the additional test data includes test results obtained from additional devices.

10. A system in accordance with claim 6, wherein the additional test data includes test results obtained from additional tests performed on each of the devices.

11. A system in accordance with claim 6, wherein the fewer test data includes test results obtained from fewer devices.

12. A system in accordance with claim 6, wherein the predetermined threshold includes a maximum failure rate for the devices.

13. A system in accordance with claim 6, wherein the predetermined threshold defines a maximum range of test data from the devices, wherein the statistics related to the test data are compared to the maximum range of test data of predetermined threshold, and wherein the code for selectively adjusting the tester adjusts the tester to obtain additional test data when the statistics are outside of the maximum range of the predetermined threshold.

14. A system in accordance with claim 1, wherein the statistics related to the test data are compared to a predetermined trend, and wherein the code for selectively adjusting the tester adjusts the tester to obtain additional test data when the statistics indicate more failures than the predetermined trend.

15. A system in accordance with claim 14, wherein the statistics related to the test data are compared to the predetermined trend, and wherein the code for selectively adjusting the tester readjusts the tester to obtain fewer test data when the statistics indicate less failures than the predetermined trend.

16. A system in accordance with claim 1, wherein the statistics related to the test data are compared to the predetermined trend, and wherein the code for selectively adjusting the tester readjusts the tester to obtain additional test data when the statistics are outside of a given range of the predetermined trend.

17. A system in accordance with claim 16, wherein the statistics related to the test data are compared to the predetermined trend, and wherein the code for selectively adjusting the tester readjusts the tester to obtain fewer test data when the statistics return within the given range of the predetermined trend.

18. A method for selectively logging test data, the method comprising:
monitoring the test data generated by a plurality of devices and generating statistics related to the test data; and
in response to the statistics related to the test data, selectively adjusting a tester that generates the test data, to modify the test data obtained from the devices.

19. A method in accordance with claim 18, further comprising generating a feedback signal for selectively adjusting the tester corresponding to the statistics related to the test data, wherein the feedback signal selectively adjusts the test data obtained by the tester from the devices.

20. A method in accordance with claim 19, further comprising comparing the statistics related to the test data to a predetermined threshold, and obtaining additional test data when the statistics are outside of the predetermined threshold.

21. A method in accordance with claim 20, wherein the obtaining additional test data includes obtaining test results from additional devices.

22. A method in accordance with claim 21, wherein the obtaining additional test data includes obtaining test results from additional tests performed on each of the devices.

23. A method in accordance with claim 21, further comprising readjusting the tester to obtain fewer test data when the statistics return within the predetermined threshold.

24. A method in accordance with claim 23, wherein the readjusting the tester to obtain fewer test data includes obtaining test results from fewer devices.

29. A method in accordance with claim 23, wherein readjusting the tester to obtain fewer test data includes obtaining test results by performing fewer tests on each of the devices.
